(19) United States
(12) Patent Application Publication
(10) Pub. No.: US 2025/0203628 A1
(43) Pub. Date: Jun. 19, 2025

(54) PRECODING INDICATION FOR SIMULTANEOUS MULTI-PANEL UL TRANSMISSION

(71) Applicant: Lenovo (Beijing) Limited, Beijing (CN)

(72) Inventors: Bingchao Liu, Beijing (CN); Chenxi Zhu, Beijing (CN); Lingling Xiao, Beijing (CN); Wei Ling, Beijing (CN); Yi Zhang, Beijing (CN)

(73) Assignee: Lenovo (Beijing) Limited, Beijing (CN)

(21) Appl. No.: 18/844,292

(22) PCT Filed: Apr. 29, 2022
(86) PCT No.: PCT/CN2022/090474

§ 371 Date: Sep. 5, 2024

(51) Int. Cl. H04W 72/231; H04B 7/06; H04W 72/1268

(52) U.S. Cl. CPC H04W 72/231; H04B 7/063; H04B 7/0639; H04W 72/1268

(57) ABSTRACT

Methods and apparatuses for precoding indication for simultaneous multi-panel UL transmission are disclosed. In one embodiment, a UE comprises a transceiver; and a processor coupled to the transceiver, wherein the processor is configured to receive, via the transceiver, a DCI containing at least one TPMI field indicating a precoding matrix, the DCI schedules a multi-panel simultaneous PUSCH transmission with up to 4 layers; and determine, for the UE equipped with a first panel and a second panel, a precoding matrix used for the first panel and a precoding matrix used for the second panel according to the at least one TPMI field.

### FIELD

The subject matter disclosed herein generally relates to wireless communications, and more particularly relates to methods and apparatuses for precoding indication for simultaneous multi-panel UL transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Downlink Control Information (DCI), Spatial Division Multiplex (SDM), Physical Uplink Shared Channel (PUSCH), Sounding Reference Signal (SRS), transmission reception point (TRP), Frequency Division Multiplex (FDM), Physical Resource Block (PRB), Transmission Configuration Indicator (TCI), Transmit Precoding Matrix Indicator (TPMI), transmit rank indicator (TRI), Code Division Multiplex (CDM), Demodulation Reference Signal (DMRS), Channel State Information Reference Signal (CSI-RS).

One typical development for simultaneous multi-panel UL transmission is single-DCI based SDM multi-panel PUSCH transmission, where different PUSCH layers scheduled by a single DCI are transmitted by different panels (e.g. two panels) by using different precoding matrices (e.g. two precoding matrices). All the scheduling information including the precoding matrices and the SRS resource used for the PUSCH transmission shall be contained in the scheduling DCI.

This disclosure targets the issue of precoding indication to support single-DCI based simultaneous multi-panel UL transmission.

### BRIEF SUMMARY

Methods and apparatuses for precoding indication for simultaneous multi-panel UL transmission are disclosed.

In one embodiment, a UE comprises a transceiver; and a processor coupled to the transceiver, wherein the processor is configured to receive, via the transceiver, a DCI containing at least one TPMI field indicating a precoding matrix, the DCI schedules a multi-panel simultaneous PUSCH transmission with up to 4 layers; and determine, for the UE equipped with a first panel and a second panel, a precoding matrix used for the first panel and a precoding matrix used for the second panel according to the at least one TPMI field.

In some embodiment, the DCI contains a first TPMI field and a second TPMI field, the PUSCH transmission is SDM based simultaneous multi-panel PUSCH transmission, and the precoding matrix indicated by the first TPMI field is the precoding matrix used for the first panel, and the precoding matrix indicated by the second TPMI field is the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is both the precoding matrix used for the first panel and the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is the precoding matrix used for the first panel, and the precoding matrix indicated by the second TPMI field is the precoding matrix used for the second panel, and the rank of the precoding matrix indicated by the first TPMI field is equal to the rank of the precoding matrix indicated by the second TPMI field.

In some embodiment, the DCI contains one TPMI field and a TRI field, the PUSCH transmission is SDM based simultaneous multi-panel PUSCH transmission, and the precoding matrix used for the first panel and the precoding matrix used for the second panel are determined by the precoding matrix indicated by the one TPMI field and a rank combination corresponding to the first panel and the second pane indicated by the TRI field. In particular, the rank combination includes first rank (rank1) for the first panel and second rank (rank2) for the second panel, wherein the sum of rank1 and rank2 is equal to the rank of the precoding matrix indicated by the one TPMI field, a matrix part of the precoding matrix used for the first panel is first rank1 part of the matrix part of the precoding matrix indicated by the one TPMI field, a scaling factor of the precoding matrix used for the first panel is determined by the matrix part of the precoding matrix used for the first panel to ensure the power of modulated data does not increase after applying the precoding matrix used for the first panel and ensure the transmit power of the pre-coded data over each used antenna port of the first panel is the same, and the matrix part of the precoding matrix used for the second panel is last rank2 part of the matrix part of the precoding matrix indicated by the one TPMI field, a scaling factor of the precoding matrix used for the second panel is determined by the matrix part of the precoding matrix used for the second panel to ensure the power of modulated data does not increase after applying the precoding matrix used for the second panel and ensure the transmit power of the pre-coded data over each used antenna port of the second panel is the same. When precoding matrix is used for a panel having four antenna ports, the power of modulated data does not increase after applying the precoding matrix comprising: when all of the four antenna ports are used for data transmission, the power of modulated data does not change after applying the precoding matrix, and when one or two or three antenna ports are not used for data transmission, the scaling factor of the precoding matrix is fixed as 1/2. In some embodiment, the DCI contains one TPMI field and a TRI field, the PUSCH transmission is FDM based simultaneous multi-panel PUSCH transmission, and the precoding matrix indicated by the one TPMI field is both the precoding matrix used for the first panel and the precoding matrix used for the second panel.

In some embodiment, the DCI contains one TPMI field and an ‘antenna port(s)’ field, the PUSCH transmission is SDM based simultaneous multi-panel PUSCH transmission, and the precoding matrix used for the first panel and the precoding matrix used for the second panel are determined by the precoding matrix indicated by the one TPMI field and a first rank of the precoding matrix used for the first panel and a second rank of the precoding matrix used for the second panel indicated by the ‘antenna port(s)’ field. In particular, the sum of the first rank (rank1) and the second rank (rank2) is equal to the rank of the precoding matrix indicated by the one TPMI field, a matrix part of the precoding matrix used for the first panel is first rank1 part of the matrix part of the precoding matrix indicated by the one TPMI field, a scaling factor of the precoding matrix used for the first panel is determined by the matrix part of the precoding matrix used for the first panel to ensure the power of modulated data does not increase after applying the precoding matrix used for the first panel and ensure the transmit power of the pre-coded data over each used antenna port of the first panel is the same, and the matrix part of the precoding matrix used for the second panel is last rank2 part of the matrix part of the precoding matrix indicated by the one TPMI field, a scaling factor of the precoding matrix used for the second panel is determined by the matrix part of the precoding matrix used for the second panel to ensure the power of modulated data does not increase after applying the precoding matrix used for the second panel and ensure the transmit power of the pre-coded data over each used antenna port of the second panel is the same. When a precoding matrix is used for a panel having four antenna ports, the power of modulated data does not increase after applying the precoding matrix comprising: when all of the four antenna ports are used for data transmission, the power of modulated data does not change after applying the precoding matrix, and when one or two or three antenna ports are not used for data transmission, the scaling factor of the precoding matrix is fixed as 1/2.

In some embodiment, the processor is further configured to receive, via the transceiver, a max rank restriction to indicate a maximal total number of layers of the multi-panel simultaneous PUSCH transmission. In particular, the rank of the precoding matrix indicated by the TPMI field is equal to a total number of layers of the multi-panel simultaneous PUSCH transmission, wherein the total number is equal to or smaller than the maximal total number.

In another embodiment, a method performed at a UE comprises receiving a DCI containing at least one TPMI field indicating a precoding matrix, the DCI schedules a multi-panel simultaneous PUSCH transmission with up to 4 layers; and determining, for the UE equipped with a first panel and a second panel, a precoding matrix used for the first panel and a precoding matrix used for the second panel according to the at least one TPMI field.

In still another embodiment, a base unit comprises a transceiver; and a processor coupled to the transceiver, wherein the processor is configured to determine, for a UE equipped with a first panel and a second panel, a precoding matrix used for the first panel and a precoding matrix used for the second panel; and transmit, via the transceiver, a DCI scheduling a multi-panel simultaneous PUSCH transmission with up to 4 layers, the DCI contains at least one TPMI field indicating the precoding matrix used for the first panel and the precoding matrix used for the second panel.

In some embodiment, the DCI contains a first TPMI field and a second TPMI field, the PUSCH transmission is SDM based simultaneous multi-panel PUSCH transmission, and the precoding matrix indicated by the first TPMI field is the precoding matrix used for the first panel, and the precoding matrix indicated by the second TPMI field is the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is both the precoding matrix used for the first panel and the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is the precoding matrix used for the first panel, and the precoding matrix indicated by the second TPMI field is the precoding matrix used for the second panel, and the rank of the precoding matrix indicated by the first TPMI field is equal to the rank of the precoding matrix indicated by the second TPMI field.

In some embodiment, the DCI contains one TPMI field and a TRI field, the PUSCH transmission is SDM based simultaneous multi-panel PUSCH transmission, and the one TPMI field indicates a precoding matrix for the first panel and the second panel, the TRI field indicates a rank combination corresponding to the first panel and the second panel. In particular, the rank combination includes first rank (rank1) for the first panel and second rank (rank2) for the second panel, wherein the sum of rank1 and rank2 is equal to the rank of the precoding matrix indicated by the one TPMI field, first rank 1 part of the matrix part of the precoding matrix indicated by the one TPMI field is a matrix part of the precoding matrix used for the first panel, last rank2 part of the matrix part of the precoding matrix indicated by the one TPMI field is the matrix part of the precoding matrix used for the second panel. In some embodiment, the DCI contains one TPMI field and a TRI field, the PUSCH transmission is FDM based simultaneous multi-panel PUSCH transmission, and the one TPMI field indicates a precoding matrix for the first panel and the second panel.

In some embodiment, the DCI contains one TPMI field and an ‘antenna port(s)’ field, the PUSCH transmission is SDM based simultaneous multi-panel PUSCH transmission, and the one TPMI field indicates a precoding matrix for the first panel and the second panel, and the ‘antenna port(s)’ field indicates a first rank of the precoding matrix used for the first panel and a second rank of the precoding matrix used for the second panel. In particular, the sum of the first rank (rank1) and the second rank (rank2) is equal to the rank of the precoding matrix indicated by the one TPMI field, first rank1 part of the matrix part of the precoding matrix indicated by the one TPMI field is a matrix part of the precoding matrix used for the first panel, and last rank2 part of the matrix part of the precoding matrix indicated by the one TPMI field is the matrix part of the precoding matrix used for the second panel.

In some embodiment, the processor is further configured to transmit a max rank restriction to indicate a maximal total number of layers of the multi-panel simultaneous PUSCH transmission. In particular, the rank of the precoding matrix indicated by the TPMI field is equal to a total number of layers of the multi-panel simultaneous PUSCH transmission, wherein the total number is equal to or smaller than the maximal total number.

In yet another embodiment, a method performed at a base unit comprises determining, for a UE equipped with a first panel and a second panel, a precoding matrix used for the first panel and a precoding matrix used for the second panel; and transmitting a DCI scheduling a multi-panel simultaneous PUSCH transmission with up to 4 layers, the DCI contains at least one TPMI field indicating the precoding matrix used for the first panel and the precoding matrix used for the second panel.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a scenario of single-DCI based multi-panel/TRP SDM based simultaneous PUSCH transmission;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

“Multi-TRP” means that a serving cell can have multiple (e.g. two) TRPs. “Multi-panel” means that a UE can have multiple (e.g. two) panels at least for UL transmission. In the condition that a UE with two panels (e.g. panel #0 and panel #1) transmits UL signal (e.g. PUSCH transmissions) to a serving cell with two TRPs (e.g. TRP #0 and TRP #1), the UE may use one panel (e.g. panel #0) to transmit UL signal to one TRP (e.g. TRP #0) of the serving cell and use the other panel (e.g. panel #1) to transmit UL signal to another TRP (e.g. TRP #1) of the serving cell. So, one panel is associated with one TRP. For example, panel #0 is associated with TRP #0, and panel #1 is associated with TRP #1. So, multi-panel multi-TRP scenario can be described as multi-panel/TRP.

When two SRS resource sets for codebook or non-codebook are configured in a BWP of a cell to support multi-panel/TRP based UL transmission, each SRS resource set may correspond to a panel. The SRS resource set ID can be used to identify a panel. For example, the SRS resource set with lower SRS resource set ID corresponds to a first panel and the SRS resource set with larger SRS resource set ID corresponds to a second panel.

Incidentally, in the following description, ‘PUSCH transmission’ may be abbreviated as ‘PUSCH’.

“Multi-panel/TRP simultaneous UL transmission” means the UE transmit UL signals from multiple panels (e.g. two panels) to multiple TRPs (e.g. two TRPs) simultaneously.

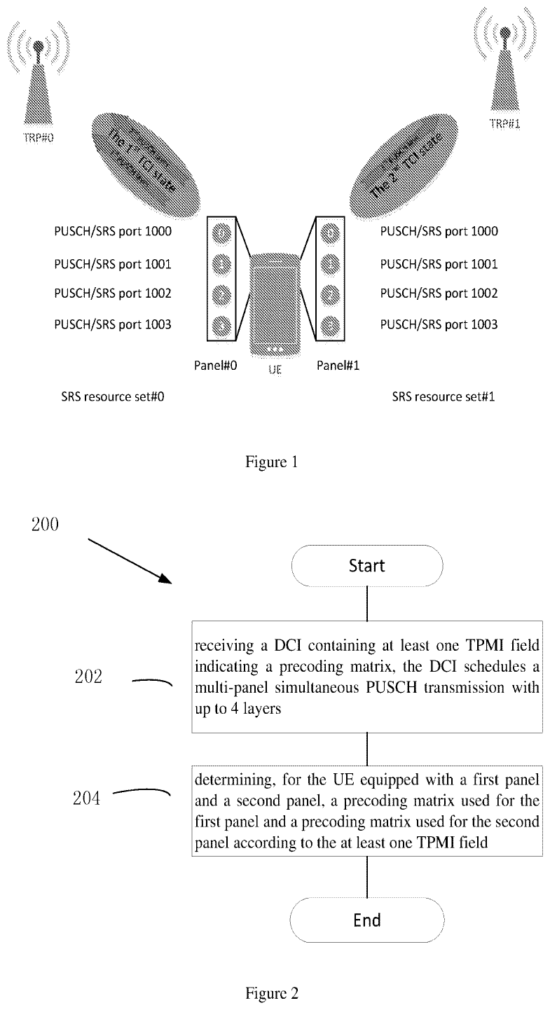

A multi-panel/TRP (e.g. two panels and two TRPs) scenario is illustrated in FIG. 1. Two panels (e.g. panel #0 and panel #1) are equipped for the UE for simultaneous UL transmission, where each panel has the same number of antenna ports (e.g. 4 antenna ports or 2 antenna ports). Two SRS resource sets used for codebook or non-codebook are configured for the UE in a BWP of a cell. Panel #0 can be identified by SRS resource set #0, and Panel #1 can be identified by SRS resource set #1. Each of the two panels used for simultaneous UL transmission reports a same coherent capability. For single-DCI based multi-panel/TRP simultaneous PUSCH transmission, a single DCI schedules a PUSCH transmission to be transmitted by both panel #0 and panel #1 or by either panel #0 or panel #1.

The UE can be configured in two different modes for PUSCH multi-antenna precoding, referred as codebook (CB) based transmission and non-codebook (nCB) based transmission, respectively. When the UE is configured with codebook based PUSCH transmission, one or two SRS resource sets used for codebook can be configured in a BWP of a cell for the UE. When the UE is configured with non-codebook based PUSCH transmission, one or two SRS resource sets used for non-codebook can be configured in a BWP of a cell for the UE. To enable codebook based PUSCH transmission, the UE shall be configured to transmit one or more SRS resources used for codebook for channel measurement. Based on the measurements on the configured SRS resources, the gNB determines a suitable rank and the precoding matrix from a pre-defined codebook, which includes a set of precoding matrices with different ranks, and sends the information to the UE.

For non-codebook based PUSCH transmission, the UE is required to measure a CSI-RS to obtain the channel information based on channel reciprocity. The UE selects what it believes is a suitable uplink precoder and applies the selected precoder to a set of configured SRS resources with one SRS resource being transmitted on each layer defined by the precoder. Based on the received SRS resources, the gNB decides to modify the UE-selected precoder for the scheduled PUSCH transmission.

Two UL or joint TCI states are activated or indicated by a single TCI codepoint for UL signal transmitted from two panels to two TRPs for one BWP of a cell if unified TCI framework is configured, and are referred to as two indicated UL TCI states. UL TCI state is indicated when separate DL/UL TCI framework is configured, where the Tx beam for UL transmit and the Rx beam for DL reception are separately indicated by UL TCI state and DL TCI state, respectively. Each UL TCI state indicates a DL RS or an SRS resource for the UE to determine the TX spatial filter, i.e., the TX beam, for UL transmission. Joint TCI state is indicated when joint DL/UL TCI framework is configured, where both Tx beam for UL transmission and Rx beam for DL reception are determined by the indicated joint TCI state. Each joint TCI state indicates a DL RS for the UE to determine the TX spatial filter for UL transmission, and the RX spatial filter, i.e., the RX beam, for DL reception. The first TCI state is applied to the UL transmission from a first panel and the second TCI state is applied to the UL transmission from a second panel. In the scenario illustrated in FIG. 1, the first TCI state is applied to the first and the second PUSCH layers transmitted by Panel #0, and the second TCI state is applied to the third PUSCH layers from Panel #1.

Simultaneous multi-panel/TRP PUSCH transmission can be SDM based simultaneous multi-panel/TRP PUSCH transmission (i.e. SDM based multi-panel/TRP PUSCH scheme) or FDM based simultaneous multi-panel/TRP PUSCH transmission (i.e. FDM based multi-panel/TRP PUSCH scheme).

For SDM based multi-panel/TRP PUSCH scheme, a first set of PUSCH layer(s) of a PUSCH are transmitted by a first panel (e.g. panel #0) by using the first indicated UL TCI state, and a second set of PUSCH layer(s) of the same PUSCH are transmitted by the second panel (e.g. panel #1) by using the second indicated UL TCI state.

For FDM based PUSCH scheme, a first set of frequency resources (PRBs) are allocated for the PUSCH transmitted by the first panel using the first indicated UL TCI state, and a second set of frequency resources (PRBs) are allocated for the PUSCH transmitted by the second panel using the second indicated UL TCI state.

FIG. 1 illustrates a scenario of single-DCI based multi-panel/TRP SDM based simultaneous PUSCH transmission: a single DCI schedules a PUSCH transmission with 3 layers (i.e. 3 PUSCH layers) to be transmitted by both panel #0 and panel #1. Each PUSCH layer is transmitted by 4 antenna ports (e.g. PUSCH or SRS antenna ports) 1000, 1001, 1002, 1003 of a panel. Each antenna port is represented as PUSCH/SRS port in FIG. 1.

The maximum total number of PUSCH layer(s) transmitted across both panels at a same time, which can be also referred to as maximum rank restriction, is indicated by a higher layer parameter maxRank for a UE in a BWP of a cell. For example, if the higher layer parameter maxRank is configured with a value of 4, that the total number of PUSCH layer(s) transmitted across both panels cannot exceed 4 (i.e. equal to or smaller than 4). In other words, the maximum number of PUSCH layers of the scheduled PUSCH transmission is 4.

In the example of FIG. 1, the total number of PUSCH layers is 3, which is smaller than the maximal total number of 4. The first PUSCH layer and the second PUSCH layer are transmitted by PUSCH antenna port 1000, 1001, 1002, 1003 of the first panel (panel #0) to TRP #0 by using the first indicated TCI state, and the third PUSCH layer is transmitted by PUSCH antenna port 1000, 1001, 1002, 1003 of the second panel (panel #1) to TRP #1 by using the second indicated TCI state.

When the PUSCH layers are transmitted from two panels of the UE, a precoding matrix selected from a specified codebook is used for each panel to perform UL precoding on modulated data for the PUSCH transmission from a panel. The UE shall perform UL precoding according to Equation 1 and Equation 2 corresponding to each panel.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {ν}_{0} - 1 )} ( i )\end{matrix} ] \qquad Equation 1$$

where, the block of vector [y₀⁽⁰⁾(i) . . . y₀^{(v}^{₀}⁻¹⁾(i)]^{T} is the modulated data that will be transmitted from the first panel (e.g. panel #0); W₀ is the precoding matrix applied to the first block of vector; and the block of vector [z₀^{(P}^{₀₎}(i) . . . z₀^{(P}^{ₚ₋₁₎}(i)]^{T} is the pre-coded data to be transmitted by the antenna port(s) of the first panel by applying the first indicated UL TCI state. V₀ indicates the number of PUSCH layers transmitted by the first panel. P₀ corresponds to PUSCH antenna port 1000 of the first panel and Pₚ₋₁ corresponds to PUSCH antenna port 1000+p-1 of the first panel.

$$[ \begin{matrix}{z}_{1}^{( {P}_{0} )} ( i ) \\ ⋮ \\ {z}_{1}^{( {P}_{ρ - 1} )} ( i )\end{matrix} ] = {W}_{1} [ \begin{matrix}{y}_{1}^{( 0 )} ( i ) \\ ⋮ \\ {y}_{1}^{( {ν}_{1} - 1 )} ( i )\end{matrix} ] \qquad Equation 2$$

where, the block of vector [y₁⁽⁰⁾(i) . . . y₁^{(v}^{₁}⁻¹⁾(i)]^{T} is the modulated data that will be transmitted from the second panel (e.g. panel #1); W₁ is the precoding matrix applied to the second block of vector; and the block of vector [z₁^{(p}^{₀₎}(i) . . . z₁^{(P}^{ₚ}⁻¹⁾(i)]^{T} is the pre-coded data to be transmitted by the antenna port(s) of the second panel by applying the second indicated UL TCI state. V₁ indicates the number of PUSCH layers transmitted by the second panel. P₀ corresponds to PUSCH antenna port 1000 of the second panel and Pₚ-1 corresponds to PUSCH antenna port 1000+p-1 of the second panel.

W₀ and W₁ can be the same precoding matrix or different precoding matrices.

For FDM scheme, the UL precoding is performed similar to SDM scheme. W₀ is applied to the first set of frequency resources to be transmitted from the first panel, and W₁ is applied to the second set of frequency resources to be transmitted from the second panel. For FDM scheme, the PUSCH layer(s) transmitted from the first panel and the PUSCH layer(s) transmitted from the second panel shall be the same. It means that the rank of W₀ and the rank of W₁ shall be the same and should not exceed the maximum rank restriction.

Traditionally, only one precoding matrix is indicated in the DCI scheduling the PUSCH transmission, e.g. in the TPMI field of the scheduling DCI. When two precoding matrices (e.g. W₀ and W₁) are necessary to be indicated, different solutions are proposed.

According to a first embodiment, two precoding matrices are indicated by two TPMI fields contained in the scheduling DCI, where each TPMI field indicates one precoding matrix.

According to the first embodiment, two TPMI fields are configured to be contained in the DCI with format 0_1 or 0_2 scheduling PUSCH transmission (e.g. single-DCI based simultaneous multi-panel/TRP PUSCH transmission).

The precoding matrix applied to the first set of PUSCH layer(s) to be transmitted from a first panel (e.g. panel #0) and the precoding matrix applied to the second set of PUSCH layer(s) to be transmitted from a second panel (e.g. panel #1) are independently indicated by two TPMI fields contained in the scheduling DCI.

The first TPMI field indicates the precoding matrix (e.g. W₀) used for the first panel corresponding to the first indicated UL TCI state.

The second TPMI field indicates the precoding matrix (e.g. W₁) used for the second panel corresponding to the second indicated UL TCI state.

Each of the first TPMI field and the second TPMI field has up to 6 bits, and indicates a TPMI index, i.e., the TPMI field value, (e.g. TPMI index from Tables 6.3.1.5-1 to 6.3.1.5-7 of 3GPP Technical Specification TS38.211 v16.0.0), which indicates a precoding matrix.

Tables 6.3.1.5-3, 6.3.1.5-5, 6.3.1.5-6 and 6.3.1.5-7 are for single-layer transmission, two-layer transmission, three-layer transmission and four-layer transmission for CP-OFDM based PUSCH transmission (i.e., the transform precoding is disabled), respectively. Each TPMI index from each of Tables 6.3.1.5-3, 6.3.1.5-5, 6.3.1.5-6 and 6.3.1.5-7 indicates a precoding matrix using four antenna ports with transform precoding disabled.

### Below are Table 6.3.1.5-3, 6.3.1.5-5, 6.3.1.5-6 and 6.3.1.5-7.

TABLE 6.3.1.5-3
Precoding matrix W for single-layer transmission using four
antenna ports with transform precoding disabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6.3.1.5-5
Precoding matrix W tor two-layer transmission using four
antenna ports with transform precoding disabled

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6.3.1.5-6
Precoding matrix W for three-layer transmission using four
antenna ports with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6.3.1.5-7
Precoding matrix W for four-layer transmission using four
antenna ports with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

For SDM based simultaneous multi-TRP PUSCH transmission, the rank of W₀ indicates the number of layer(s) to be transmitted by the first panel, and the rank of W₁ indicates the number of layer(s) to be transmitted by the second panel.

For FDM based multi-TRP simultaneous PUSCH transmission, the rank of W₀ and the rank of W₁ shall be the same. So, a first solution is that both the precoding matrix W₀ used for the first panel and the precoding matrix W₁ used for the second panel are indicated by the first TPMI field. It means that the same precoding matrix is used for both the first panel and the second panel. A second solution is that the precoding matrix W₀ used for the first panel/TRP and the precoding matrix W₁ used for the second panel/TRP are independently indicated by the first TPMI field and the second TPMI field, and the precoding matrix W₀ and the precoding matrix W₁ are required to have the same rank (e.g. from the same Table 6.3.1.5-3 or from the same Table 6.3.1.5-5).

At the gNB's side, when the precoding matrix W₀ used for the first panel and the precoding matrix W₁ used for the second panel are determined, the precoding matrix W₀ is indicated by the first TPMI field, and the precoding matrix W₁ is indicated by the second TPMI field.

An example of the first embodiment is described as follows:

It is assumed that a UE is equipped with three panels. Two of the three panels are activated and can be used in simultaneous multi-panel/TRP UL transmission. Each of the activated panels can support up to 4 SRS ports, i.e. each panel has 4 antenna ports. In addition, two SRS resource sets used for codebook are configured for the UE in a BWP of a cell. Each SRS resource set contains two 4-ports SRS resources.

It is assumed that the UE receives a DCI scheduling an SDM based simultaneous multi-panel/TRP PUSCH transmission, and two TPMI fields (e.g. a first TPMI field and a second TPMI field) are contained in the DCI.

It is supposed that the first TPMI field indicates a TPMI index 8 in Table 6.3.1.5-3, and the second TPMI field indicates a TPMI index 4 in Table 6.3.1.5-5.

The TPMI index 8 in Table 6.3.1.5-3 indicates the precoding matrix

$${W}_{0} = {\frac{1}{2} [ 0101 ]}^{T}$$

for single-layer transmission using four antenna ports. The TPMI index 4 in Table 6.3.1.5-5 indicates the precoding matrix

$${W}_{1} = {\frac{1}{2} [ \begin{matrix}0 & 1 & 0 & 0 \\ 0 & 0 & 0 & 1\end{matrix} ]}^{T}$$

for two-layer transmission using four antenna ports. So, the UE shall transmit a PUSCH with 3 layers (a first layer, a second layer and a third layer), wherein the first layer is transmitted by the first panel by applying the precoding matrix

$${W}_{0} = {\frac{1}{2} [ \begin{matrix}0 & 1 & 0 & 1\end{matrix} ]}^{T} ,$$

and the second layer and the third layer are transmitted by the second panel by applying the precoding matrix

$${W}_{1} = {\frac{1}{2} [ \begin{matrix}0 & 1 & 0 & 0 \\ 0 & 0 & 0 & 1\end{matrix} ]}^{T} .$$

A second embodiment relates to indicating two precoding matrices by one TPMI field and one TRI field.

According to the second embodiment, the precoding matrix applied to the first set of PUSCH layer(s) associated with a first panel, and the precoding matrix applied to the second set of PUSCH layer(s) associated with a second panel are jointly indicated by one TPMI field and one TRI field, which is a new field, contained in the DCI with format 0_1 or 0_2 scheduling the PUSCH.

The one TPMI field indicates a precoding matrix from Table 6.3.1.5-3, or Table 6.3.1.5-5, or Table 6.3.1.5-6, or Table 6.3.1.5-7 which will be applied to the modulated data for the first panel and the second panel. The indicated precoding matrix has a rank being equal to the total number of PUSCH layer(s) of the scheduled PUSCH across both panels.

The TRI field indicates the total rank combination for the first panel and the second panel. Two TRI indication solutions are proposed.

TRI indication solution 1 is illustrated in Table 1

TABLE 1
Rank combination indication by transmit rank indicator
field including both single-panel/TRP and multi-
panel/TRP based PUSCH transmission scheduling

| TRI | first | second | |
|---|---|---|---|
| index | rank | rank | Description |
| 0 | 1 | 0 | A rank 1 PUSCH is scheduled to be transmitted |
| | | | from the first panel. (Single-panel/TRP based |
| | | | PUSCH transmission is scheduled) |
| 1 | 0 | 1 | A rank 1 PUSCH is scheduled to be transmitted |
| | | | from the second panel. (Single-panel/TRP based |
| | | | PUSCH transmission is scheduled) |
| 2 | 2 | 0 | A rank 2 PUSCH is scheduled to be transmitted |
| | | | from the first panel. (Single-panel/TRP based |
| | | | PUSCH transmission is scheduled) |
| 3 | 0 | 2 | A rank 2 PUSCH is scheduled to be transmitted |
| | | | from the second panel. (Single-panel/TRP based |
| | | | PUSCH transmission is scheduled) |
| 4 | 3 | 0 | A rank 3 PUSCH is scheduled to be transmitted |
| | | | from the first panel. (Single-panel/TRP based |
| | | | PUSCH transmission is scheduled) |
| 5 | 0 | 3 | A rank 3 PUSCH is scheduled to be transmitted |
| | | | from the second panel. (Single-panel/TRP based |
| | | | PUSCH transmission is scheduled) |
| 6 | 4 | 0 | A rank 4 PUSCH is scheduled to be transmitted |
| | | | from the first panel. (Single-panel/TRP based |
| | | | PUSCH transmission is scheduled) |
| 7 | 0 | 4 | A rank 4 PUSCH is scheduled to be transmitted |
| | | | from the second panel. (Single-panel/TRP based |
| | | | PUSCH transmission is scheduled) |
| 8 | 1 | 1 | A rank 2 PUSCH is scheduled, where the first |
| | | | layer is transmitted from the first panel and |
| | | | the second layer is transmitted from the second |
| | | | panel. (Multi-panel/TRP based PUSCH |
| | | | transmission is scheduled) |
| 9 | 1 | 2 | A rank 3 PUSCH is scheduled, where the first |
| | | | layer is transmitted from the first panel and |
| | | | the last 2 layers are transmitted from the second |
| | | | panel. (Multi-panel/TRP based PUSCH |
| | | | transmission is scheduled) |
| 10 | 2 | 1 | A rank 3 PUSCH is scheduled, where the first |
| | | | 2 layers are transmitted from the first panel and |
| | | | the last layer is transmitted from the second |
| | | | panel. (Multi-panel/TRP based PUSCH |
| | | | transmission is scheduled) |
| 11 | 2 | 2 | A rank 4 PUSCH is scheduled, where the first |
| | | | 2 layers are transmitted from the first panel and |
| | | | the last 2 layers are transmitted from the second |
| | | | panel. (Multi-panel/TRP based PUSCH |
| | | | transmission is scheduled) |
| 12 | 1 | 3 | A rank 4 PUSCH is scheduled, where the first |
| | | | layer is transmitted from the first panel and |
| | | | the last 3 layers are transmitted from the second |
| | | | panel. (Multi-panel/TRP based PUSCH |
| | | | transmission is scheduled) |
| 13 | 3 | 1 | A rank 4 PUSCH is scheduled, where the first 3 |
| | | | layers are transmitted from the first panel and |
| | | | the last layer is transmitted from the second |
| | | | panel. (Multi-panel/TRP based PUSCH |
| | | | transmission is scheduled) |

Table 1 lists all possible combinations first rank and second rank for a scheduled PUSCH transmission with up to 4 PUSCH layers, where first rank indicates the number of PUSCH layer(s) transmitted from the first panel (e.g. panel #0), and second rank indicates the number of PUSCH layer(s) transmitted from the second panel (e.g. panel #1). When first rank or second rank is equal to 0, the PUSCH transmission is a single-panel/TRP PUSCH transmission, i.e. transmitted from only one panel of the UE to the corresponding TRP. For example, if first rank=0, the PUSCH transmission is transmitted only from the second panel (e.g. panel #1); and if second rank=0, the PUSCH transmission is transmitted only from the first panel (e.g. panel #0).

For TRI indication solution 1, the TRI field has up to 4 bits (for up to 14 different TRI indices). So, the total DCI overhead (one TPMI field of 6 bits and one TRI field of 4 bits) is 10 bits, that saves 2 bits compared to the first embodiment in which the total DCI overhead (two TPMI fields each of 6 bits) is 12 bits.

TRI indication solution 2 is illustrated in Table2.

TABLE 2
Rank combination indication by transmit rank indicator field
including multi-panel/TRP based PUSCH transmission scheduling

| TRI | first | second | |
|---|---|---|---|
| index | rank | rank | Description |
| 0 | 1 | 1 | A rank 2 PUSCH is scheduled, where the |
| | | | first layer is transmitted from the first |
| | | | panel and the second layer is transmitted |
| | | | from the second panel. |
| 1 | 1 | 2 | A rank 3 PUSCH is scheduled, where the |
| | | | first layer is transmitted from the first |
| | | | panel and the last 2 layers are transmitted |
| | | | from the second panel. |
| 2 | 2 | 1 | A rank 3 PUSCH is scheduled, where the |
| | | | first 2 layers are transmitted from the first |
| | | | panel and the last layer is transmitted |
| | | | from the second panel. |
| 3 | 2 | 2 | A rank 4 PUSCH is scheduled, where the first |
| | | | 2 layers are transmitted from the first panel |
| | | | and the last 2 layers are transmitted |
| | | | from the second panel. |
| 4 | 1 | 3 | A rank 4 PUSCH is scheduled, where the first |
| | | | layer is transmitted from the first panel |
| | | | and the last 3 layers are transmitted |
| | | | from the second panel. |
| 5 | 3 | 1 | A rank 4 PUSCH is scheduled, where the first |
| | | | 3 layers are transmitted from the first |
| | | | panel and the last layer is transmitted |
| | | | from the second panel. |

If the single-panel/TRP PUSCH scheme or multi-panel/TRP PUSCH scheme can be distinguished by another field in the scheduling DCI, e.g., by the SRS resource set indicator field, the TRI field can be further simplified as in Table 2, which lists all possible combinations first rank and second rank only for a scheduled multi-panel/TRP PUSCH transmission with up to 4 PUSCH layers, where first rank indicates the number of PUSCH layer(s) transmitted from the first panel (e.g. panel #0), and second rank indicates the number of PUSCH layer(s) transmitted from the second panel (e.g. panel #1).

For TRI indication solution 2, the TRI field has up to 3 bits (for up to 6 different TRI indices). So, the total DCI overhead (one TPMI field of 6 bits and one TRI field of 3 bits) is 9 bits, that saves 3 bits compared to the first embodiment in which the total DCI overhead (two TPMI fields each of 6 bits) is 12 bits.

With either TRI indication solution 1 or 2, a combination of first rank and second rank is indicated. That is, each TRI index indicates the number of PUSCH layer(s) to be transmitted from the first panel (i.e. first rank) and the number of PUSCH layer(s) to be transmitted from the second panel (i.e. second rank). The rank of the precoding matrix indicated by the one TPMI field shall be equal to the sum of first rank and second rank. For example, if the one TPMI field indicates a precoding matrix with rank=3, the TRI index, as shown in Table 1 or Table 2 shall be first rank=1 and second rank=2 (TRI index 9 in Table 1 or TRI index 1 in Table 2) or first rank=2 and second rank=1 (TRI index 10 in Table 1 or TRI index 2 in Table 2), suppose multi-panel/TRP PUSCH transmission is scheduled. If single-panel/TRP PUSCH transmission is scheduled, it is possible to indicate TRI index 4 or 5 in Table 1.

The precoding matrix indicated by the one TPMI field has a scaling factor and a matrix part. For example, if the TPMI field indicates a TPMI index 4 in Table 6.3.1.5-6, i.e. the precoding matrix is

$$\frac{1}{2 \sqrt{3}} [ \begin{matrix}1 & 1 & 1 \\ 1 & - 1 & 1 \\ j & j & - j \\ j & - j & - j\end{matrix} ] ,$$

the scaling factor is

$$\frac{1}{2 \sqrt{3}} ,$$

and the matrix part is

$${[ \begin{matrix}1 & 1 & j & j \\ 1 & - 1 & j & - j \\ 1 & 1 & - j & - j\end{matrix} ]}^{T} .$$

The scaling factor is used to ensure that the power of modulated data does not increase after applying a precoding matrix. When all antenna ports of a panel are used, the scaling factor ensures that the power of modulated data does not change after applying the precoding matrix, which means the square root of sum of the square of each element of the matrix part multiplying the scaling factor is equal to 1. When at least one of the antenna ports of the panel is not used (e.g. if a panel is equipped with four antenna ports, one or two or three antenna ports are not used for data transmission according to the precoding matrix applied to the panel), the scaling factor of the precoding matrix is fixed as 1/2. In addition, the scaling factor ensures that the pre-coded data transmitted over each used antenna port of the panel using the precoding matrix has the same transmit power.

In the above example of the precoding matrix

$$\frac{1}{2 \sqrt{3}} [ \begin{matrix}1 & 1 & 1 \\ 1 & - 1 & 1 \\ j & j & - j \\ j & - j & - j\end{matrix} ] ,$$

all of four antenna ports are used. The sum of the square of each element of the matrix part is 1²+1²+j²+j²+1²+(−1)²+j²+(−j)²+1²+1²+(−j)²+(−j)²=12. So, the square root of the sum of the square of each element of the matrix part (\sqrt{12}) multiplies the scaling factor

$$( \frac{1}{2 \sqrt{3}} )$$

is equal to 1. Further,
the transmit power of the data over each antenna port is the same:

$${( \frac{1}{2 \sqrt{3}} )}^{2} \times 3 = \frac{1}{4} .$$

For another example, if the precoding matrix is

$$\frac{1}{2} [ \begin{matrix}1 & 0 & 0 \\ 0 & 1 & 0 \\ 0 & 0 & 1 \\ 0 & 0 & 0\end{matrix} ]$$

(e.g. the TPMI field indicates a TPMI index 0 in

Table 6.3.1.5-6), the scaling factor is fixed as 1/2 because the fourth antenna port is not used for data transmission (i.e. the fourth element in each of three columns of the precoding matrix is 0).

When the precoding matrix indicated by the one TPMI field (referred to as indicated precoding matrix) applies to the precoding matrix applied to the first set of PUSCH layer(s) associated with the first panel (i.e. W₀) and the precoding matrix applied to the second set of PUSCH layer(s) associated with the second panel (i.e. W₁), first rank part (which means first rank number of column(s)) of the matrix part of the indicated precoding matrix is the matrix part of W₀, and the scaling factor of W₀ is determined by the matrix part of W₀ so that when all the antenna ports of the first panel are used for data transmission, the power of W₀ is 1; and when at least one of the antenna ports of the first panel is not used for data transmission (which means not all of the antenna ports of the first panel are used for data transmission), the scaling factor of W₀ is fixed as 1/2; and last second rank part (which means last second rank number of column(s)) of the matrix part of the indicated precoding matrix is the matrix part of W₁, and the scaling factor of W₁ is determined by the matrix part of W₁ so that when all the antenna ports of the second panel are used for data transmission, the power of W₁ is 1; and when at least one of the antenna ports of the second panel is not used for data transmission (which means not all of the antenna ports of the second panel are used for data transmission), the scaling factor of W₁ is fixed as 1/2.

For example, if first rank=2 and second rank=1, then the matrix part of W₀ is first 2 columns of the indicated precoding matrix, that is

$${[ \begin{matrix}1 & 1 & j & j \\ 1 & - 1 & j & - j\end{matrix} ]}^{T} ,$$

which indicates that all of the four antenna ports of the first panel are used for data transmission, and the matrix part of W₁ is last 1 column of the indicated precoding matrix, that is [1 1-j-j]^{T}, which indicates that all of the four antenna ports of the second panel are used for data transmission. The scaling factor of W₀ is determined according to the matrix part of

$${W}_{0} ( {[ \begin{matrix}1 & 1 & j & j \\ 1 & - 1 & j & - j\end{matrix} ]}^{T} )$$

so that the power of W₀ is 1. That is, the square root of sum of the square of each element of the matrix part of W₀ multiplying the scaling factor of W₀ is equal to 1: the sum of the square of each element of the matrix part of W₀, i.e. 1²+1²+j²+j²+1²+(−1)²+j²+(−j)² is 8, and accordingly, the scaling factor of W₀ is

$$\frac{1}{2 \sqrt{2}} .$$

The scaling factor of W₁ is determined according to the matrix part of W₁ [1 1-j-j]^{T} so that the power of W₁ is 1. That is, the square root of sum of the square of each element of the matrix part of W₁ multiplying the scaling factor of W₁ is equal to 1: the sum of the square of each element of the matrix part of W₁, i.e. 1²+1²+(−j)²+(−j)² is 4, and accordingly, the scaling factor of W₁ is 1/2.

As a whole, the precoding matrix applied to the first set of PUSCH layer(s) (i.e. W₀) is

$${\frac{1}{2 \sqrt{2}} [ \begin{matrix}1 & 1 & j & j \\ 1 & - 1 & j & - j\end{matrix} ]}^{T} ,$$

and the precoding matrix applied to the second set of PUSCH layer(s) (i.e. W₁) is

$${\frac{1}{2} [ \begin{matrix}1 & 1 & - j & - j\end{matrix} ]}^{T} .$$

As a whole, for SDM based multi-TRP transmission, the precoding matrix W₀ used for the first panel and the precoding matrix W₁ used for the second panel are indicated jointly by the one TPMI field and the TRI field as described above.

For FDM based multi-TRP transmission, the rank of W₀ and the rank of W₁ shall be the same. So, both the precoding matrix W₀ used for the first panel and the precoding matrix W₁ used for the second panel are the precoding matrix indicated by the first TPMI field.

At the gNB's side, when the precoding matrix W₀ used for the first panel and the precoding matrix W₁ used for the second panel are determined, the matrix part of W₀ and the matrix part of W₁ are combined as a matrix part of a precoding matrix for both the first panel and the second panel. The matrix part of the precoding matrix for both the first panel and the second panel is indicated by the one TPMI field by indicating a precoding matrix that has both a matrix part of the precoding matrix used for the first panel and a matrix part of the precoding matrix used for the second panel. In addition, a combination of the rank of the precoding matrix W₀ and the rank of the precoding matrix W₁ is indicated in the TRI field by referring to Table 1 or Table 2.

A third embodiment relates to indicating two precoding matrices by one TPMI field and an existing ‘antenna port(s)’ field.

In the second embodiment, the TRI field indicates the rank combination for the first panel and the second panel. In the third embodiment, the existing ‘antenna port(s)’ field implicitly indicates a first rank (e.g. rank1) for the first panel and a second rank (e.g. rank2) for the second panel. The ‘antenna port(s)’ field indicates one or more DMRS ports used for the PUSCH demodulation, and each indicated DMRS port corresponds to a PUSCH layer. For the example provided in FIG. 1, three DMRS ports should be indicated by the ‘antenna port(s)’ field. Two DMRS types named DMRS type 1 and DMRS type 2 are specified in NR Release 15. Up to 8 DMRS ports, i.e., DMRS ports 0, 1, . . . , 7 are supported for DMRS type 1. DMRS ports 0, 1, 4 and 5 belong to CDM group 0, and DMRS ports 2, 3, 6 and 7 belong to CDM group 1. Up to 12 DMRS ports, i.e., DMRS ports 0, 1, . . . , 11 are supported for DMRS type 2. DMRS ports 0, 1, 6 and 7 belong to CDM group 0, DMRS ports 2, 3, 8 and 9 belong to CDM group 1 and DMRS port 4, 5, 10 and 11 belong to CDM group 2.

When SDM based multi-TRP transmission is scheduled, the indicated DMRS ports, selected from 8 DMRS ports when DMRS type 1 is configured or selected from 12 DMRS ports when DMRS type 2 is configured, should be from two different CDM groups and are selected based on a specified DMRS indication table. A first CDM group is one of the two CDM groups that contains the first indicated DMRS port, and a second CDM group is the other of the two CDM groups. The first rank corresponding to the first panel is determined by the number of DMRS ports within the first CDM group, and the second rank corresponding to the second panel is determined by the number of DMRS ports within the second CDM group.

For SDM based multi-TRP transmission, the precoding matrix W₀ used for the first panel and the precoding matrix W₁ used for the second panel are indicated jointly by the one TPMI field and the first rank and the second rank implicitly indicated by the ‘antenna port(s)’ field, with the same manner as described in the second embodiment.

For FDM based multi-TRP transmission, the rank of W₀ and the rank of W₁ shall be the same. So, both the precoding matrix W₀ used for the first panel and the precoding matrix W₁ used for the second panel are indicated by the one TPMI field.

At the gNB's side, when the precoding matrix W₀ used for the first panel and the precoding matrix W₁ used for the second panel are determined, the matrix part of W₀ and the matrix part of W₁ are combined as a matrix part of a precoding matrix for both the first panel and the second panel. Both the matrix part of the precoding matrix used for the first panel and the matrix part of the precoding matrix used for the second panel are indicated by the one TPMI field by indicating a precoding matrix that has a matrix part by combining the matrix part of the precoding matrix used for the first panel and the matrix part of the precoding matrix used for the second panel. In addition, the rank of the precoding matrix W₀ and the rank of the precoding matrix W₁ are determined by the ‘antenna port(s)’ field.

FIG. 2 is a schematic flow chart diagram illustrating an embodiment of a method 200 according to the present application. In some embodiments, the method 200 is performed by an apparatus, such as a remote unit (e.g. UE). In certain embodiments, the method 200 may be performed by a processor executing program code, for example, a microcontroller, a microprocessor, a CPU, a GPU, an auxiliary processing unit, a FPGA, or the like.

The method 200 is a method performed at a UE, comprising: 202 receiving a DCI containing at least one TPMI field indicating a precoding matrix, the DCI schedules a multi-panel simultaneous PUSCH transmission with up to 4 layers; and 204 determining, for the UE equipped with a first panel and a second panel, a precoding matrix used for the first panel and a precoding matrix used for the second panel according to the at least one TPMI field.

In some embodiment, the DCI contains a first TPMI field and a second TPMI field, the PUSCH transmission is SDM based simultaneous multi-panel PUSCH transmission, and the precoding matrix indicated by the first TPMI field is the precoding matrix used for the first panel, and the precoding matrix indicated by the second TPMI field is the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is both the precoding matrix used for the first panel and the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is the precoding matrix used for the first panel, and the precoding matrix indicated by the second TPMI field is the precoding matrix used for the second panel, and the rank of the precoding matrix indicated by the first TPMI field is equal to the rank of the precoding matrix indicated by the second TPMI field.

In some embodiment, the DCI contains one TPMI field and a TRI field, the PUSCH transmission is SDM based simultaneous multi-panel PUSCH transmission, and the precoding matrix used for the first panel and the precoding matrix used for the second panel are determined by the precoding matrix indicated by the one TPMI field and a rank combination corresponding to the first panel and the second panel indicated by the TRI field. In particular, the rank combination includes first rank (rank1) for the first panel and second rank (rank2) for the second panel, wherein the sum of rank1 and rank2 is equal to the rank of the precoding matrix indicated by the one TPMI field, a matrix part of the precoding matrix used for the first panel is first rank1 part of the matrix part of the precoding matrix indicated by the one TPMI field, a scaling factor of the precoding matrix used for the first panel is determined by the matrix part of the precoding matrix used for the first panel to ensure the power of modulated data does not increase after applying the precoding matrix used for the first panel and ensure the transmit power of the pre-coded data over each used antenna port of the first panel is the same, and the matrix part of the precoding matrix used for the second panel is last rank2 part of the matrix part of the precoding matrix indicated by the one TPMI field, a scaling factor of the precoding matrix used for the second panel is determined by the matrix part of the precoding matrix used for the second panel to ensure the power of modulated data does not increase after applying the precoding matrix used for the second panel and ensure the transmit power of the pre-coded data over each used antenna port of the second panel is the same. When a precoding matrix is used for a panel having four antenna ports, the power of modulated data does not increase after applying the precoding matrix comprising: when all of the four antenna ports are used for data transmission, the power of modulated data does not change after applying the precoding matrix, and when one or two or three antenna ports are not used for data transmission, the scaling factor of the precoding matrix is fixed as 1/2. In some embodiment, the DCI contains one TPMI field and a TRI field, the PUSCH transmission is FDM based simultaneous multi-panel PUSCH transmission, and the precoding matrix indicated by the one TPMI field is both the precoding matrix used for the first panel and the precoding matrix used for the second panel.

In some embodiment, the DCI contains one TPMI field and an ‘antenna port(s)’ field, the PUSCH transmission is SDM based simultaneous multi-panel PUSCH transmission, and the precoding matrix used for the first panel and the precoding matrix used for the second panel are determined by the precoding matrix indicated by the one TPMI field and a first rank of the precoding matrix used for the first panel and a second rank of the precoding matrix used for the second panel indicated by the ‘antenna port(s)’ field. In particular, the sum of the first rank (rank1) and the second rank (rank2) is equal to the rank of the precoding matrix indicated by the one TPMI field, a matrix part of the precoding matrix used for the first panel is first rank1 part of the matrix part of the precoding matrix indicated by the one TPMI field, a scaling factor of the precoding matrix used for the first panel is determined by the matrix part of the precoding matrix used for the first panel to ensure the power of modulated data does not increase after applying the precoding matrix used for the first panel and ensure the transmit power of the pre-coded data over each used antenna port of the first panel is the same, and the matrix part of the precoding matrix used for the second panel is last rank2 part of the matrix part of the precoding matrix indicated by the one TPMI field, a scaling factor of the precoding matrix used for the second panel is determined by the matrix part of the precoding matrix used for the second panel to ensure the power of modulated data does not increase after applying the precoding matrix used for the second panel and ensure the transmit power of the pre-coded data over each used antenna port of the second panel is the same. When a precoding matrix is used for a panel having four antenna ports, the power of modulated data does not increase after applying the precoding matrix comprising: when all of the four antenna ports are used for data transmission, the power of modulated data does not change after applying the precoding matrix, and when one or two or three antenna ports are not used for data transmission, the scaling factor of the precoding matrix is fixed as 1/2.

In some embodiment, the method further comprises receiving a max rank restriction to indicate a maximal total number of layers of the multi-panel simultaneous PUSCH transmission. In particular, the rank of the precoding matrix indicated by the TPMI field is equal to a total number of layers of the multi-panel simultaneous PUSCH transmission, wherein the total number is equal to or smaller than the maximal total number.

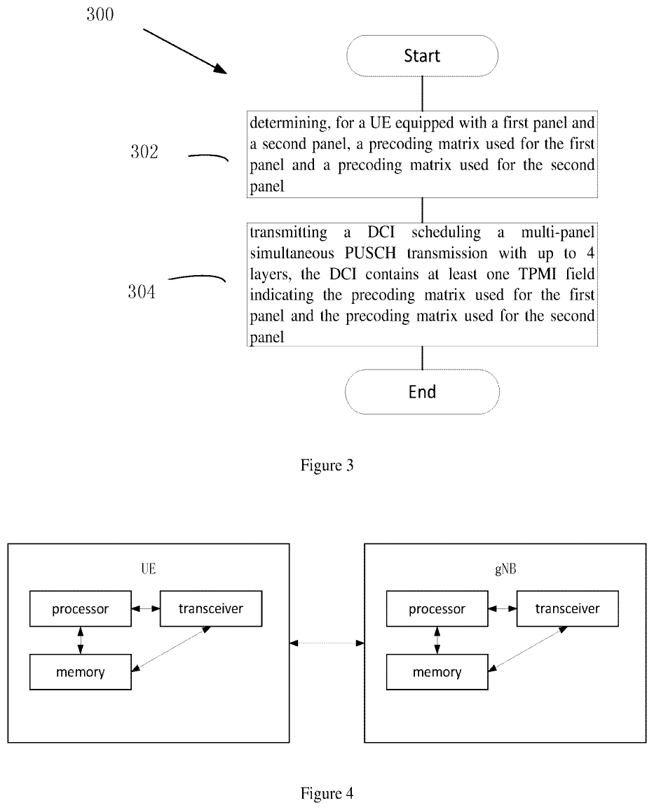

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise 302 determining, for a UE equipped with a first panel and a second panel, a precoding matrix used for the first panel and a precoding matrix used for the second panel; and 304 transmitting a DCI scheduling a multi-panel simultaneous PUSCH transmission with up to 4 layers, the DCI contains at least one TPMI field indicating the precoding matrix used for the first panel and the precoding matrix used for the second panel.

In some embodiment, the DCI contains a first TPMI field and a second TPMI field, the PUSCH transmission is SDM based simultaneous multi-panel PUSCH transmission, and the precoding matrix indicated by the first TPMI field is the precoding matrix used for the first panel, and the precoding matrix indicated by the second TPMI field is the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is both the precoding matrix used for the first panel and the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is the precoding matrix used for the first panel, and the precoding matrix indicated by the second TPMI field is the precoding matrix used for the second panel, and the rank of the precoding matrix indicated by the first TPMI field is equal to the rank of the precoding matrix indicated by the second TPMI field.

In some embodiment, the DCI contains one TPMI field and a TRI field, the PUSCH transmission is SDM based simultaneous multi-panel PUSCH transmission, and the one TPMI field indicates a precoding matrix for the first panel and the second panel, the TRI field indicates a rank combination corresponding to the first panel and the second panel. In particular, the rank combination includes first rank (rank1) for the first panel and second rank (rank2) for the second panel, wherein the sum of rank1 and rank2 is equal to the rank of the precoding matrix indicated by the one TPMI field, first rank1 part of the matrix part of the precoding matrix indicated by the one TPMI field is a matrix part of the precoding matrix used for the first panel, last rank2 part of the matrix part of the precoding matrix indicated by the one TPMI field is the matrix part of the precoding matrix used for the second panel. In some embodiment, the DCI contains one TPMI field and a TRI field, the PUSCH transmission is FDM based simultaneous multi-panel PUSCH transmission, and the one TPMI field indicates a precoding matrix for the first panel and the second panel.

In some embodiment, the DCI contains one TPMI field and an ‘antenna port(s)’ field, the PUSCH transmission is SDM based simultaneous multi-panel PUSCH transmission, and the one TPMI field indicates a precoding matrix for the first panel and the second panel, and the ‘antenna port(s)’ field indicates a first rank of the precoding matrix used for the first panel and a second rank of the precoding matrix used for the second panel. In particular, the sum of the first rank (rank1) and the second rank (rank2) is equal to the rank of the precoding matrix indicated by the one TPMI field, first rank1 part of the matrix part of the precoding matrix indicated by the one TPMI field is a matrix part of the precoding matrix used for the first panel, and last rank2 part of the matrix part of the precoding matrix indicated by the one TPMI field is the matrix part of the precoding matrix used for the second panel.

In some embodiment, the method may further comprise transmitting a max rank restriction to indicate a maximal total number of layers of the multi-panel simultaneous PUSCH transmission. In particular, the rank of the precoding matrix indicated by the TPMI field is equal to a total number of layers of the multi-panel simultaneous PUSCH transmission, wherein the total number is equal to or smaller than the maximal total number.

FIG. 4 is a schematic block diagram illustrating apparatuses according to one embodiment.

Referring to FIG. 4, the UE (i.e. the remote unit) includes a processor, a memory, and a transceiver. The processor implements a function, a process, and/or a method which are proposed in FIG. 2.

The UE comprises a transceiver; and a processor coupled to the transceiver, wherein the processor is configured to receive, via the transceiver, a DCI containing at least one TPMI field indicating a precoding matrix, the DCI schedules a multi-panel simultaneous PUSCH transmission with up to 4 layers; and determine, for the UE equipped with a first panel and a second panel, a precoding matrix used for the first panel and a precoding matrix used for the second panel according to the at least one TPMI field.

In some embodiment, the DCI contains a first TPMI field and a second TPMI field, the PUSCH transmission is SDM based simultaneous multi-panel PUSCH transmission, and the precoding matrix indicated by the first TPMI field is the precoding matrix used for the first panel, and the precoding matrix indicated by the second TPMI field is the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is both the precoding matrix used for the first panel and the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is the precoding matrix used for the first panel, and the precoding matrix indicated by the second TPMI field is the precoding matrix used for the second panel, and the rank of the precoding matrix indicated by the first TPMI field is equal to the rank of the precoding matrix indicated by the second TPMI field.

In some embodiment, the DCI contains one TPMI field and a TRI field, the PUSCH transmission is SDM based simultaneous multi-panel PUSCH transmission, and the precoding matrix used for the first panel and the precoding matrix used for the second panel are determined by the precoding matrix indicated by the one TPMI field and a rank combination corresponding to the first panel and the second panel indicated by the TRI field. In particular, the rank combination includes first rank (rank1) for the first panel and second rank (rank2) for the second panel, wherein the sum of rank1 and rank2 is equal to the rank of the precoding matrix indicated by the one TPMI field, a matrix part of the precoding matrix used for the first panel is first rank1 part of the matrix part of the precoding matrix indicated by the one TPMI field, a scaling factor of the precoding matrix used for the first panel is determined by the matrix part of the precoding matrix used for the first panel to ensure the power of modulated data does not increase after applying the precoding matrix used for the first panel and ensure the transmit power of the pre-coded data over each used antenna port of the first panel is the same, and the matrix part of the precoding matrix used for the second panel is last rank2 part of the matrix part of the precoding matrix indicated by the one TPMI field, a scaling factor of the precoding matrix used for the second panel is determined by the matrix part of the precoding matrix used for the second panel to ensure the power of modulated data does not increase after applying the precoding matrix used for the second panel and ensure the transmit power of the pre-coded data over each used antenna port of the second panel is the same. When a precoding matrix is used for a panel having four antenna ports, the power of modulated data does not increase after applying the precoding matrix comprising: when all of the four antenna ports are used for data transmission, the power of modulated data does not change after applying the precoding matrix, and when one or two or three antenna ports are not used for data transmission, the scaling factor of the precoding matrix is fixed as 1/2. In some embodiment, the DCI contains one TPMI field and a TRI field, the PUSCH transmission is FDM based simultaneous multi-panel PUSCH transmission, and the precoding matrix indicated by the one TPMI field is both the precoding matrix used for the first panel and the precoding matrix used for the second panel.

In some embodiment, the DCI contains one TPMI field and an ‘antenna port(s)’ field, the PUSCH transmission is SDM based simultaneous multi-panel PUSCH transmission, and the precoding matrix used for the first panel and the precoding matrix used for the second panel are determined by the precoding matrix indicated by the one TPMI field and a first rank of the precoding matrix used for the first panel and a second rank of the precoding matrix used for the second panel indicated by the ‘antenna port(s)’ field. In particular, the sum of the first rank (rank1) and the second rank (rank2) is equal to the rank of the precoding matrix indicated by the one TPMI field, a matrix part of the precoding matrix used for the first panel is first rank1 part of the matrix part of the precoding matrix indicated by the one TPMI field, a scaling factor of the precoding matrix used for the first panel is determined by the matrix part of the precoding matrix used for the first panel to ensure the power of modulated data does not increase after applying the precoding matrix used for the first panel and ensure the transmit power of the pre-coded data over each used antenna port of the first panel is the same, and the matrix part of the precoding matrix used for the second panel is last rank2 part of the matrix part of the precoding matrix indicated by the one TPMI field, a scaling factor of the precoding matrix used for the second panel is determined by the matrix part of the precoding matrix used for the second panel to ensure the power of modulated data does not increase after applying the precoding matrix used for the second panel and ensure the transmit power of the pre-coded data over each used antenna port of the second panel is the same. When a precoding matrix is used for a panel having four antenna ports, the power of modulated data does not increase after applying the precoding matrix comprising: when all of the four antenna ports are used for data transmission, the power of modulated data does not change after applying the precoding matrix, and when one or two or three antenna ports are not used for data transmission, the scaling factor of the precoding matrix is fixed as 1/2.

In some embodiment, the processor is further configured to receive, via the transceiver, a max rank restriction to indicate a maximal total number of layers of the multi-panel simultaneous PUSCH transmission. In particular, the rank of the precoding matrix indicated by the TPMI field is equal to a total number of layers of the multi-panel simultaneous PUSCH transmission, wherein the total number is equal to or smaller than the maximal total number.

The gNB (i.e. the base unit) includes a processor, a memory, and a transceiver. The processor implements a function, a process, and/or a method which are proposed in FIG. 3.

The base unit comprises a transceiver; and a processor coupled to the transceiver, wherein the processor is configured to determine, for a UE equipped with a first panel and a second panel, a precoding matrix used for the first panel and a precoding matrix used for the second panel; and transmit, via the transceiver, a DCI scheduling a multi-panel simultaneous PUSCH transmission with up to 4 layers, the DCI contains at least one TPMI field indicating the precoding matrix used for the first panel and the precoding matrix used for the second panel.

In some embodiment, the DCI contains a first TPMI field and a second TPMI field, the PUSCH transmission is SDM based simultaneous multi-panel PUSCH transmission, and the precoding matrix indicated by the first TPMI field is the precoding matrix used for the first panel, and the precoding matrix indicated by the second TPMI field is the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is both the precoding matrix used for the first panel and the precoding matrix used for the second panel. In some embodiment, the DCI contains a first TPMI field and a second TPMI field, the PUSCH transmission is FDM based simultaneous multi-panel PUSCH transmission, and the precoding matrix indicated by the first TPMI field is the precoding matrix used for the first panel, and the precoding matrix indicated by the second TPMI field is the precoding matrix used for the second panel, and the rank of the precoding matrix indicated by the first TPMI field is equal to the rank of the precoding matrix indicated by the second TPMI field.

In some embodiment, the DCI contains one TPMI field and a TRI field, the PUSCH transmission is SDM based simultaneous multi-panel PUSCH transmission, and the one TPMI field indicates a precoding matrix for the first panel and the second panel, the TRI field indicates a rank combination corresponding to the first panel and the second panel. In particular, the rank combination includes first rank (rank1) for the first panel and second rank (rank2) for the second panel, wherein the sum of rank1 and rank2 is equal to the rank of the precoding matrix indicated by the one TPMI field, first rank 1 part of the matrix part of the precoding matrix indicated by the one TPMI field is a matrix part of the precoding matrix used for the first panel, last rank2 part of the matrix part of the precoding matrix indicated by the one TPMI field is the matrix part of the precoding matrix used for the second panel. In some embodiment, the DCI contains one TPMI field and a TRI field, the PUSCH transmission is FDM based simultaneous multi-panel PUSCH transmission, and the one TPMI field indicates a precoding matrix for the first panel and the second panel.

In some embodiment, the DCI contains one TPMI field and an ‘antenna port(s)’ field, the PUSCH transmission is SDM based simultaneous multi-panel PUSCH transmission, and the one TPMI field indicates a precoding matrix for the first panel and the second panel, and the ‘antenna port(s)’ field indicates a first rank of the precoding matrix used for the first panel and a second rank of the precoding matrix used for the second panel. In particular, the sum of the first rank (rank1) and the second rank (rank2) is equal to the rank of the precoding matrix indicated by the one TPMI field, first rank1 part of the matrix part of the precoding matrix indicated by the one TPMI field is a matrix part of the precoding matrix used for the first panel, and last rank2 part of the matrix part of the precoding matrix indicated by the one TPMI field is the matrix part of the precoding matrix used for the second panel.

In some embodiment, the processor is further configured to transmit a max rank restriction to indicate a maximal total number of layers of the multi-panel simultaneous PUSCH transmission. In particular, the rank of the precoding matrix indicated by the TPMI field is equal to a total number of layers of the multi-panel simultaneous PUSCH transmission, wherein the total number is equal to or smaller than the maximal total number.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive downlink control information (DCI) containing a first transmit precoding matrix indicator (TPMI) field and a second TPMI field that schedules a spatial division multiplex (SDM)-based multi-panel simultaneous physical uplink shared channel (PUSCH) transmission with up to four layers; and
determine, for the UE equipped with a first panel and a second panel, a first precoding matrix indicated by the first TPMI field is the precoding matrix used for the first panel and a second precoding matrix indicated by the second TPMI field is the precoding matrix used for the second panel.

2. (canceled)

3. The UE of claim 1, wherein the first precoding matrix indicated by the first TPMI field and the second precoding matrix indicated by the second TPMI field are the precoding matrix used for the first panel and the second panel.

4. The UE of claim 1, wherein a rank of the first precoding matrix indicated by the first TPMI field is equal to the rank of the second precoding matrix indicated by the second TPMI field.

5. The UE of claim 1, wherein:
the DCI contains a transmit rank indicator (TRI) field; and
the first precoding matrix used for the first panel and the second precoding matrix used for the second panel are determined by the precoding matrix indicated by the TPMI field and a rank combination corresponding to the first panel and the second panel indicated by the TRI field.

6. The UE of claim 5, wherein:
the rank combination includes first rank (rank1) for the first panel and second rank (rank2) for the second panel, wherein a sum of rank1 and rank2 is equal to a rank of the precoding matrix indicated by the TPMI field;
a matrix part of the first precoding matrix used for the first panel is first rank1 part of the matrix part of the first precoding matrix indicated by the TPMI field, a scaling factor of the first precoding matrix used for the first panel is determined by the matrix part of the first precoding matrix used for the first panel configured for power of modulated data does not increase after applying the first precoding matrix used for the first panel and transmit power of pre-coded data over each used antenna port of the first panel is the same; and
a matrix part of the second precoding matrix used for the second panel is last rank2 part of the matrix part of the second precoding matrix indicated by the TPMI field, a scaling factor of the second precoding matrix used for the second panel is determined by the matrix part of the second precoding matrix used for the second panel configured for power of modulated data does not increase after applying the second precoding matrix used for the second panel and the transmit power of each used antenna port of the second panel is the same.

7. The UE of claim 6, wherein, when the precoding matrix is used for a panel having four antenna ports, the power of the modulated data does not increase after applying the precoding matrix comprising:
when all of the four antenna ports are used for data transmission, the power of the modulated data does not change after applying the precoding matrix, and
when one or two or three antenna ports are not used for the data transmission, the scaling factor of the precoding matrix is fixed as one-half.

8. (canceled)

9. The UE of claim 1, wherein:
the DCI contains an antenna port(s) field; and
the first precoding matrix used for the first panel and the second precoding matrix used for the second panel are determined by the precoding matrix indicated by the TPMI field and a first rank of the first precoding matrix used for the first panel and a second rank of the second precoding matrix used for the second panel indicated by the antenna port(s) field.

10. The UE of claim 9, wherein:
a sum of the first rank (rank1) and a second rank (rank2) is equal to a rank of the precoding matrix indicated by the TPMI field;
a matrix part of the first precoding matrix used for the first panel is first rank1 part of the matrix part of the first precoding matrix indicated by the TPMI field, a scaling factor of the first precoding matrix used for the first panel is determined by the matrix part of the first precoding matrix used for the first panel configured for power of modulated data does not increase after applying the first precoding matrix used for the first panel and transmit power of pre-coded data over each used antenna port of the first panel is the same; and
matrix part of the second precoding matrix used for the second panel is last rank2 part of the matrix part of the second precoding matrix indicated by the TPMI field, a scaling factor of the second precoding matrix used for the second panel is determined by the matrix part of the second precoding matrix used for the second panel configured for power of modulated data does not increase after applying the second precoding matrix used for the second panel and the transmit power of the pre-coded data over each used antenna port of the second panel is the same.

11. The UE of claim 10, wherein, when the precoding matrix is used for a panel having four antenna ports, the power of the modulated data does not increase after applying the precoding matrix comprising:
when all of the four antenna ports are used for data transmission, the power of the modulated data does not change after applying the precoding matrix, and
when one or two or three antenna ports are not used for the data transmission, the scaling factor of the precoding matrix is fixed as one-half.

12. The UE of claim 1, wherein the at least one processor is configured to cause the UE to receive a max rank restriction to indicate a maximal total number of layers of the multi-panel simultaneous PUSCH transmission.

13. The UE of claim 12, wherein a rank of the precoding matrix indicated by the TPMI field is equal to a total number of layers of the multi-panel simultaneous PUSCH transmission, wherein the total number is equal to or smaller than the maximal total number.

14. A method performed by a user equipment (UE), the method comprising:
receiving downlink control information (DCI) containing a first transmit precoding matrix indicator (TPMI) field and a second TPMI field that schedules a spatial division multiplex (SDM)-based multi-panel simultaneous physical uplink shared channel (PUSCH) transmission with up to four layers; and
determining, for the UE equipped with a first panel and a second panel, a first precoding matrix indicated by the first TPMI field is the precoding matrix used for the first panel and a second precoding matrix indicated by the second TPMI field is the precoding matrix used for the second panel.

15. A base unit, comprising:
at least one memory; and
at least one processor coupled with the at least one memory and configured to cause the base unit to:
determine, for a UE equipped with a first panel and a second panel, a first precoding matrix used for a first panel and a second precoding matrix used for a second panel; and
transmit downlink control information (DCI) that schedules a multi-panel simultaneous PUSCH transmission with up to 4 layers, the DCI contains at least one TPMI field indicating the precoding matrix used for the first panel and the precoding matrix used for the second panel.

16. A processor for wireless communication, comprising:
at least one controller coupled with at least one memory and configured to cause the processor to:
receive downlink control information (DCI) containing a first transmit precoding matrix indicator (TPMI) field and a second TPMI field that schedules a spatial division 1 multiplex (SDM)-based multi-panel simultaneous physical uplink shared channel (PUSCH) transmission with up to four layers; and
determine, for a user equipment (UE) equipped with a first panel and a second panel, a first precoding matrix indicated by the first TPMI field is the precoding matrix used for the first panel and a second precoding matrix indicated by the second TPMI field is the precoding matrix used for the second panel.

17. The processor of claim 16, wherein the first precoding matrix indicated by the first TPMI field and the second precoding matrix indicated by the second TPMI field are the precoding matrix used for the first panel and the second panel.

18. The processor of claim 16, wherein a rank of the first precoding matrix indicated by the first TPMI field is equal to the rank of the second precoding matrix indicated by the second TPMI field.

19. The processor of claim 16, wherein:
the DCI contains a transmit rank indicator (TRI) field; and
the first precoding matrix used for the first panel and the second precoding matrix used for the second panel are determined by the precoding matrix indicated by the TPMI field and a rank combination corresponding to the first panel and the second panel indicated by the TRI field.

20. The processor of claim 19, wherein:
the rank combination includes first rank (rank1) for the first panel and second rank (rank2) for the second panel, wherein a sum of rank1 and rank2 is equal to a rank of the precoding matrix indicated by the TPMI field;
a matrix part of the first precoding matrix used for the first panel is first rank1 part of the matrix part of the first precoding matrix indicated by the TPMI field, a scaling factor of the first precoding matrix used for the first panel is determined by the matrix part of the first precoding matrix used for the first panel configured for power of modulated data does not increase after applying the first precoding matrix used for the first panel and transmit power of pre-coded data over each used antenna port of the first panel is the same; and
a matrix part of the second precoding matrix used for the second panel is last rank2 part of the matrix part of the second precoding matrix indicated by the TPMI field, a scaling factor of the second precoding matrix used for the second panel is determined by the matrix part of the second precoding matrix used for the second panel configured for power of modulated data does not increase after applying the second precoding matrix used for the second panel and the transmit power of each used antenna port of the second panel is the same.

21. The processor of claim 20, wherein, when the precoding matrix is used for a panel having four antenna ports, the power of the modulated data does not increase after applying the precoding matrix comprising:
when all of the four antenna ports are used for data transmission, the power of the modulated data does not change after applying the precoding matrix, and
when one or two or three antenna ports are not used for the data transmission, the scaling factor of the precoding matrix is fixed as one-half.

22. The processor of claim 16, wherein:
the DCI contains an antenna port(s) field; and
the first precoding matrix used for the first panel and the second precoding matrix used for the second panel are determined by the precoding matrix indicated by the TPMI field and a first rank of the first precoding matrix used for the first panel and a second rank of the second precoding matrix used for the second panel indicated by the antenna port(s) field.
